(19) United States
(12) Patent Application Publication
(10) Pub. No.: US 2026/0148000 A1
(43) Pub. Date: May 28, 2026

(54) EXTRACTION OF VERIFIABLE PROPOSITIONS USING GENERATIVE LANGUAGE MODELS

(71) Applicant: Microsoft Technology Licensing, LLC, Redmond, WA (US)

(72) Inventor: Dasha METROPOLITANSKY, Cambridge, MA (US)

(73) Assignee: Microsoft Technology Licensing, LLC, Redmond, WA (US)

(21) Appl. No.: 18/989,773

(22) Filed: Dec. 20, 2024

Related U.S. Application Data
(60) Provisional application No. 63/725,965, filed on Nov. 27, 2024.

(51) Int. Cl. G06F 40/289; G06F 40/284; G06F 9/38

(52) U.S. Cl. CPC G06F 40/289; G06F 40/284; G06F 9/38

(57) ABSTRACT

This document relates to natural language processing using generative language models. For instance, the disclosed techniques can obtain text content, such as text output by a generative language model or authored by a human. Then, verifiable propositions can be extracted from the text content using a processing pipeline that involves filtering the text content based on one or more filtering criteria. The extracted verifiable propositions can be employed for various application scenarios, such as providing application programming interfaces to modify the original text content or provide assessments of the original text content.

In recent years, generative machine learning models have demonstrated tremendous capability at generating content. For instance, generative language models can generate text to summarize existing documents, help users draft new documents, and conduct natural language conversations with users at a very high level. However, generative machine learning models still have certain drawbacks, particularly when employed by novice users. For instance, generative language models can utilize significant computational resources (e.g., processor, memory, network, etc.), and in many cases these computational resources are used inefficiently when a novice user attempts to accomplish a given task with a generative language model.

### SUMMARY

This Summary is provided to introduce a selection of concepts in a simplified form. These concepts are further described below in the Detailed Description. This Summary is not intended to identify key features or essential features of the claimed subject matter, nor is it intended to be used to limit the scope of the claimed subject matter.

The description generally relates natural language processing using generative language models. One example includes a computer-implemented method that can include receiving text content. The method can also include extracting text segments from the text content. The method can also include filtering the extracted text segments by prompting a generative language model to evaluate the text segments according to one or more filtering criteria and receiving, from the generative language model, responses identifying individual text segments that meet the one or more filtering criteria, the filtering resulting in a filtered subset of text segments having the individual text segments that are identified by the generative language model as meeting the one or more filtering criteria. The method can also include prompting the generative language model to extract verifiable propositions from the filtered subset of text segments. The method can also include receiving the verifiable propositions extracted by the generative language model. The method can also include outputting the verifiable propositions.

Another example entails a system that includes a processor and a storage medium storing instructions. When executed by the processor, the instructions cause the system to receive text content. The instructions can also cause the system to extract text segments from the text content. The instructions can also cause the system to filter the extracted text segments by prompting a generative language model to evaluate the text segments according to one or more filtering criteria and receiving, from the generative language model, responses identifying individual text segments that meet the one or more filtering criteria, the filtering resulting in a filtered subset of text segments having the individual text segments that are identified by the generative language model as meeting the one or more filtering criteria. The instructions can also cause the system to prompt the generative language model to extract verifiable propositions from the filtered subset of text segments. The instructions can also cause the system to receive the verifiable propositions extracted by the generative language model. The instructions can also cause the system to output the verifiable propositions.

Another example includes a computer-readable storage medium storing instructions which, when executed by a processing device, cause the processing device to perform acts. The acts can include receiving text content. The acts can also include extracting text segments from the text content. The acts can also include filtering the extracted text segments by prompting a generative language model to evaluate the text segments according to one or more filtering criteria, and receiving, from the generative language model, responses identifying individual text segments that meet the one or more filtering criteria, the filtering resulting in a filtered subset of text segments having the individual text segments that are identified by the generative language model as meeting the one or more filtering criteria. The acts can also include prompting the generative language model to extract verifiable propositions from the filtered subset of text segments. The acts can also include receiving the verifiable propositions extracted by the generative language model. The acts can also include outputting the verifiable propositions.

### BRIEF DESCRIPTION OF THE DRAWINGS

The Detailed Description is described with reference to the accompanying figures. In the figures, the left-most digit(s) of a reference number identifies the figure in which the reference number first appears. The use of similar reference numbers in different instances in the description and the figures may indicate similar or identical items.

FIG. 1 illustrates an example generative language model, consistent with some implementations of the present concepts.

FIG. 2 illustrates an example processing pipeline, consistent with some implementations of the present concepts.

FIG. 3 illustrates an example of text content that can be output by a generative language model, consistent with some implementations of the present concepts.

FIG. 4 illustrates an example of text segments that can be extracted from text content, consistent with some implementations of the present concepts.

FIG. 5 illustrates an example of a first filtered subset of text segments, consistent with some implementations of the present concepts.

FIG. 6 illustrates an example of a second filtered subset of text segments, consistent with some implementations of the present concepts.

FIG. 7 illustrates an example of verifiable propositions mapped to text segments from which they were extracted, consistent with some implementations of the present concepts.

FIGS. 8A, 8B, and 9-12 illustrate examples of a graphical user interface, consistent with some implementations of the present concepts.

FIG. 13 illustrates an example of a system in which the disclosed implementations can be performed, consistent with some implementations of the present concepts.

FIG. 14 illustrates an example method or technique, consistent with some implementations of the disclosed techniques.

### DETAILED DESCRIPTION

As noted above, generative language models exhibit the ability to generate text content for a wide range of applications. However, it is not necessarily straightforward to assess the quality of text content output by a generative language model. For instance, when a generative language model is prompted to answer a question or summarize a document, the output of the generative language model can include ambiguous or incomplete statements.

In many cases, it is useful to identify specific propositions in text content output by a generative language model that can be verified as either true or false. While a generative language model could be simply prompted to extract verifiable propositions from its own output in a single step, this approach could be inefficient in terms of utilization of computing resources. In addition, this approach could result in extracting propositions that cannot be verified, are incomplete, lack context, and/or might result in missing one or more propositions.

The disclosed techniques relate to extraction of verifiable propositions from text content, such as text output by a generative language model. The disclosed implementations employ a processing pipeline with multiple filtering stages that remove text segments (e.g., sentences) from text content that lack verifiable propositions and/or cannot be disambiguated. Then, the remaining text segments that have not been filtered out can be processed in parallel by a generative language model that decomposes the remaining text segments into verifiable propositions.

Each text segment from the original text content can be labeled to indicate whether that text segment includes a verifiable proposition or was deemed to lack a verifiable proposition and/or was determined to be ambiguous. In addition, mappings can be output that convey which verifiable propositions were extracted from which text segments. The extracted verifiable propositions, mappings, and/or labels can be employed to provide one or more application programming interfaces that can refine text content for various use cases.

### MACHINE LEARNING OVERVIEW

There are various types of machine learning frameworks that can be trained to perform a given task. Support vector machines, decision trees, Kolmogorov-Arnold networks, state space models, and neural networks are just a few examples of machine learning frameworks that have been used in a wide variety of applications, such as image processing and natural language processing. Some machine learning frameworks, such as neural networks, use layers of nodes that perform specific operations.

In a neural network, nodes are connected to one another via one or more edges. A neural network can include an input layer, an output layer, and one or more intermediate layers. Individual nodes can process their respective inputs according to a predefined function, and provide an output to a subsequent layer, or, in some cases, a previous layer. The inputs to a given node can be multiplied by a corresponding weight value for an edge between the input and the node. In addition, nodes can have individual bias values that are also used to produce outputs. Various training procedures can be applied to learn the edge weights and/or bias values. The term “parameters” when used without a modifier is used herein to refer to learnable values such as edge weights and bias values that can be learned by training a machine learning model, such as a neural network.

A neural network structure can have different layers that perform different specific functions. For example, one or more layers of nodes can collectively perform a specific operation, such as pooling, encoding, or convolution operations. For the purposes of this document, the term “layer” refers to a group of nodes that share inputs and outputs, e.g., to or from external sources or other layers in the network. The term “operation” refers to a function that can be performed by one or more layers of nodes. The term “model structure” refers to an overall architecture of a layered model, including the number of layers, the connectivity of the layers, and the type of operations performed by individual layers. The term “neural network structure” refers to the model structure of a neural network. The term “trained model” and/or “tuned model” refers to a model structure together with parameters for the model structure that have been trained or tuned. Note that two trained models can share the same model structure and yet have different values for the parameters, e.g., if the two models are trained on different training data or if there are underlying stochastic processes in the training process.

There are many machine learning tasks for which there is a relative lack of training data. One broad approach to training a model with limited task-specific training data for a particular task involves “transfer learning.” In transfer learning, a model is first pretrained on another task for which significant training data is available, and then the model is tuned to the particular task using the task-specific training data.

The term “pretraining,” as used herein, refers to model training on a set of pretraining data to adjust model parameters in a manner that allows for subsequent tuning of those model parameters to adapt the model for one or more specific tasks. In some cases, the pretraining can involve a self-supervised learning process on unlabeled pretraining data, where a “self-supervised” learning process involves learning from the structure of pretraining examples, potentially in the absence of explicit (e.g., manually-provided) labels. Subsequent modification of model parameters obtained by pretraining is referred to herein as “tuning.” Tuning can be performed for one or more tasks using supervised learning from explicitly-labeled training data, in some cases using a different task for tuning than for pretraining.

### TERMINOLOGY

The term “text content” refers to text provided in documents such as word processing documents or web pages, text output by a generative language model, text obtained from a transcription of speech, etc. The term “text segment” refers to a portion of text content, such as a phrase, sentence, paragraph, chapter, etc. The term “verifiable proposition” refers to any statement that can be independently verified as true or false. The term “context” refers to information that occurs together with a given text segment in a given item of text content. For instance, the context for a particular text segment can include one or more other text segments that precede that text segment in a given item of text content, one or more other text segments that occur subsequently to that text segment in a given item of text content, metadata (such as a header) that is associated with that text segment, etc.

The term “generative model,” as used herein, refers to a machine learning model employed to generate new content. One type of generative model is a “generative language model,” which is a model that can generate new sequences of text given some input. One type of input for a generative language model is a natural language prompt, e.g., a query potentially with some additional context. For instance, a generative language model can be implemented as a neural network, e.g., a long short-term memory-based model, a decoder-based generative language model, etc. Examples of decoder-based generative language models include versions of models such as GPT, BLOOM, PaLM, Mistral, Gemini, and/or LLaMA. Generative language models can be trained to predict tokens in sequences of textual training data. When employed in inference mode, the output of a generative language model can include new sequences of text that the model generates.

Another type of generative model is a “generative image model,” which is a model that generates images or video. For instance, a generative image model can be implemented as a neural network, e.g., a generative image model such as one or more versions of Stable Diffusion, DALL-E, Sora, or GENIE. A generative image model can generate new image or video content using inputs such as a natural language prompt and/or an input image or video. One type of generative image model is a diffusion model, which can add noise to training images and then be trained to remove the added noise to recover the original training images. In inference mode, a diffusion model can generate new images by starting with a noisy image and removing the noise.

In some cases, a generative model can be multi-modal. For instance, a model may be capable of using various combinations of text, images, video, audio, application states, code, or other modalities as inputs and/or generating combinations of text, images, video, audio, application states, or code or other modalities as outputs. Here, the term “generative language model” encompasses multi-modal generative models where at least one mode of output includes natural language tokens. Likewise, the term “generative image model” encompasses multi-modal generative models where at least one mode of output includes images or video. Examples of multi-modal models include certain GPT variants such as GPT-4o, Gemini, Chameleon, etc. Multi-modal models can also include lightweight models such as Phi-3-Vision-128K-Instruct.

In addition, some generative models can include computer vision capabilities. These models are capable of recognizing objects in input images. The term "computer vision model" encompasses multi-modal models such as one or more versions of CLIP (Contrastive Language-Image Pre-Training) and BLIP (Bootstrapping Language-Image Pre-Training). Note the term "computer vision model" also encompasses non-generative models, such as ResNet, Faster-RCNN, etc. The term “vision language model” refers to any multi-modal generative model that can generate text describing images or videos, including CLIP, BLIP, Vision-and-Language BERT, Flamingo, Chameleon, etc.

The term “prompt,” as used herein, refers to input provided to a generative model that the generative model uses to generate outputs. A prompt can be provided in various modalities, such as text, an image, audio, video, etc. The term “language generation prompt” refers to a prompt to a generative model where the requested output is in the form of natural language. The term “image generation prompt” refers to a prompt to a generative model where the requested output is in the form of an image.

The term “machine learning model” refers to any of a broad range of models that can learn to generate automated user input and/or application output by observing properties of past interactions between users and applications. For instance, a machine learning model could be a neural network, a support vector machine, a decision tree, a clustering algorithm, etc. In some cases, a machine learning model can be trained using labeled training data, a reward function, or other mechanisms, and in other cases, a machine learning model can learn by analyzing data without explicit labels or rewards.

### EXAMPLE DECODER-BASED GENERATIVE LANGUAGE MODEL

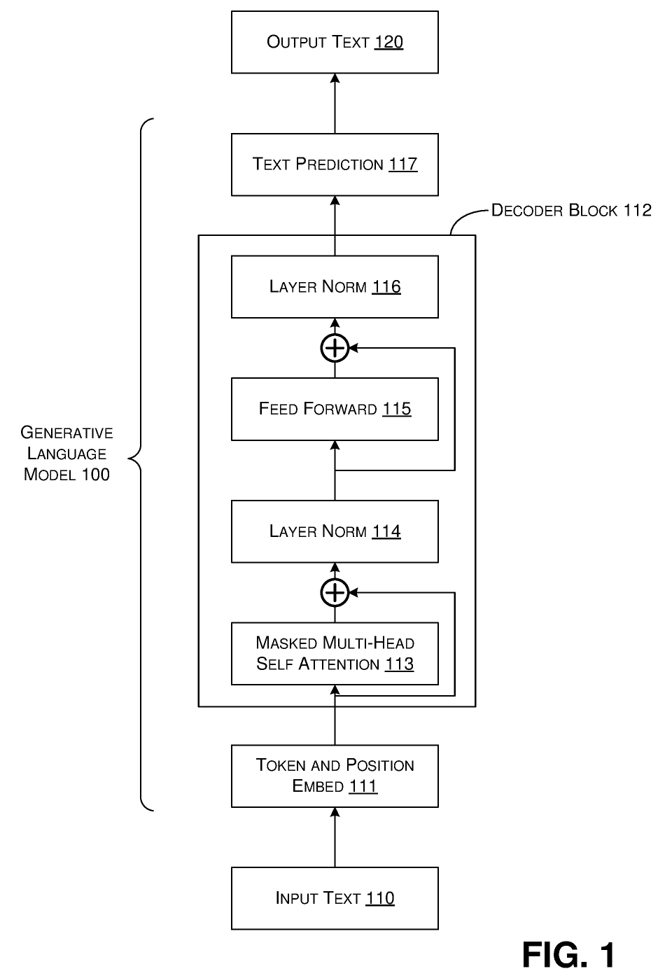

FIG. 1 illustrates an exemplary generative language model 100 (e.g., a transformer-based decoder) that can be employed using the disclosed implementations. (Radford, et al., “Improving language understanding by generative pre-training,” 2018). Generative language model 100 is an example of a machine learning model that can be used to perform one or more natural language processing tasks that involve generating text, as discussed more below. For the purposes of this document, the term “natural language” means language that is normally used by human beings for writing or conversation.

Generative language model 100 can receive input text 110, e.g., a prompt from a user or a prompt generated automatically by machine learning using the disclosed techniques. For instance, the input text can include words, sentences, phrases, or other representations of language. The input text can be broken into tokens and mapped to token and position embeddings 111 representing the input text. Token embeddings can be represented in a vector space where semantically-similar and/or syntactically-similar embeddings are relatively close to one another, and less semantically-similar or less syntactically-similar tokens are relatively further apart. Position embeddings represent the location of each token in order relative to the other tokens from the input text.

The token and position embeddings 111 are processed in one or more decoder blocks 112. Each decoder block implements masked multi-head self-attention 113, which is a mechanism relating different positions of tokens within the input text to compute the similarities between those tokens. Each token embedding is represented as a weighted sum of other tokens in the input text. Attention is only applied for already-decoded values, and future values are masked. Layer normalization 114 normalizes features to mean values of 0 and variance to 1, resulting in smooth gradients. Feed forward layer 115 transforms these features into a representation suitable for the next iteration of decoding, after which another layer normalization 116 is applied. Multiple instances of decoder blocks can operate sequentially on input text, with each subsequent decoder block operating on the output of a preceding decoder block. After the final decoding block, text prediction layer 117 can predict the next word in the sequence, which is output as output text 120 in response to the input text 110 and also fed back into the language model. The output text can be a newly-generated response to the prompt provided as input text to the generative language model. As discussed more below, in some implementations, the output text can include image generation prompts for completing a three-dimensional virtual space based on one or more input images.

Generative language model 100 can be trained using techniques such as next-token prediction or masked language modeling on a large, diverse corpus of documents. For instance, the text prediction layer 117 can predict the next token in a given document, and parameters of the decoder block 112 and/or text prediction layer can be adjusted when the predicted token is incorrect. In some cases, a generative language model can be pretrained on a large corpus of documents. In some cases, a generative language model can be trained to predict multiple output tokens in a single inference step (Gloeckle, et al., “Better & faster large language models via multi-token prediction,” April 30, 2024, arXiv preprint arXiv:2404.19737). After pretraining, the generative language model can be tuned using a reinforcement learning technique such as reinforcement learning from human feedback (“RLHF”).

### EXAMPLE PIPELINE

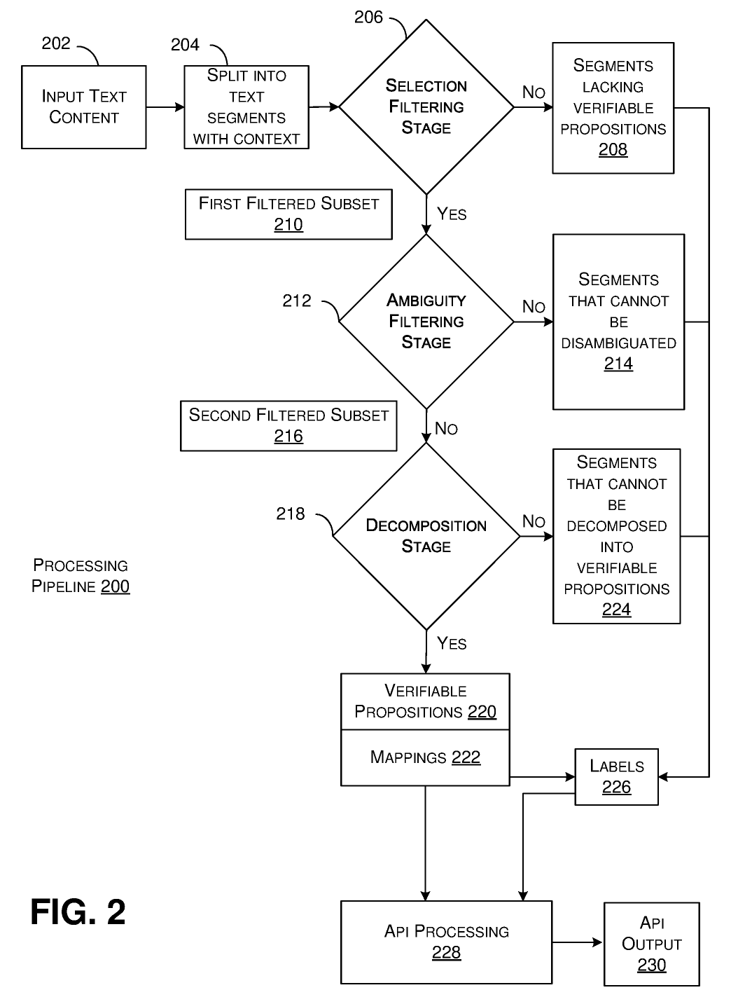

FIG. 2 illustrates a processing pipeline 200 that can be employed to extract verifiable propositions from text content using generative language model 100. Note that the processing pipeline 200 is just one example of how the disclosed concepts can be employed for extraction of verifiable propositions from text content.

At 202, text content is input to the pipeline. For instance, the text content can be an answer to a question provided by a generative language model, a summarization of one or more documents provided by a generative language model, etc. The text content can also be provided in a document at least partially authored by a human, such as a word processing document or a web page. In addition, the text content can be obtained by transcribing speech of one or more users.

At 204, the text content is split into text segments. For instance, the text content can be split into sentences extracted from the text content using a tokenizer, one or more regular expressions, the generative language model, or another machine learning model. In other implementations, the text segments can be phrases, paragraphs, or other portions of a given item of text content.

A selection filtering stage 206 removes text segments that lack verifiable propositions 208. For instance, the selection filtering stage can be implemented by inputting each extracted text segment along with some context to the generative language model 100 with a prompt requesting that the generative language model indicate whether that text segment includes any verifiable propositions. The context can include one or more preceding text segments (e.g., text segments that immediately precede the current text segment in the original text content), one or more subsequent text segments (e.g., text segments that immediately follow the current text segment in the original text content), and/or metadata, such as a header or subheader with which the current text segment is associated in the original text content.

The selection filtering stage 206 outputs a first filtered subset 210 of segments that are identified as having at least one verifiable proposition. The first filtered subset is then input to an ambiguity filtering stage 212, which detects and removes segments that cannot be disambiguated 214. For instance, the ambiguity filtering stage can be implemented by inputting each extracted text segment along with some context to the generative language model 100 with a prompt requesting that the generative language model indicate whether that text segment has ambiguity that cannot be resolved with the context.

The ambiguity filtering stage 212 outputs second filtered subset 216 of text segments that are not filtered for either lacking verifiable propositions or having ambiguity that cannot be resolved given the context. The second filtered subset is then input to a decomposition stage 218. The decomposition stage can be implemented by inputting each extracted text segment along with some context to the generative language model 100 with a prompt requesting that the generative language model decompose that text segment into one or more independently-verifiable propositions.

The decomposition stage 218 outputs extracted verifiable propositions 220. In addition, mappings 222 are provided that can identify, for each of the verifiable propositions, the corresponding text segment from which it was extracted. Each time a given text segment is processed through the filtering and decomposition stages, the verifiable propositions extracted for that text segment can be mapped to that text segment. In some cases, the decomposition stage also identifies text segments that cannot be decomposed into verifiable propositions 224. Labels 226 can be obtained indicating whether a given text segment was (1) identified as lacking verifiable propositions in selection filtering stage 206, (2) was identified as unable to be disambiguated at ambiguity filtering stage 212, (3) was unable to be decomposed into verifiable propositions at decomposition stage 218, or (4) was successfully decomposed into one or more verifiable propositions at decomposition stage 218.

API processing 228 can employ the extracted verifiable propositions 220, the mappings 222, and/or the labels 226 to provide API output 230. For instance, one or more first application programming interfaces can be provided that receive the input text content and then implement processing pipeline 200 as described above. The one or more first application programming interfaces can then output, in response to a calling application, the mappings and/or the labels. In addition, the one or more first application programming interfaces can output explanations, provided by the generative language model, for each filtering stage. For instance, explanations can be provided why certain text segments are deemed to lack verifiable propositions at selection filtering stage 206, cannot be disambiguated given the context at ambiguity filtering stage 212, and/or cannot be decomposed into verifiable propositions at decomposition stage 218.

API processing 228 can also provide API output 230 for one or more second application programming interfaces that modify the input text content using the output of the one or more first application programming interfaces. For instance, the one or more second application programming interfaces can be configured to output, to a calling application, any of the following: (1) a modified version of the input text content from which individual text segments that lack verifiable propositions have been removed, (2) a modified version of the input text content with clarifications provided by the generative language model, or (3) a modified version of the input text content where one or more individual text segments have been disambiguated by the generative language model using context from the input text content and/or from one or more external sources (e.g., additional documents retrieved via a web search).

### PIPELINE PROCESSING EXAMPLE

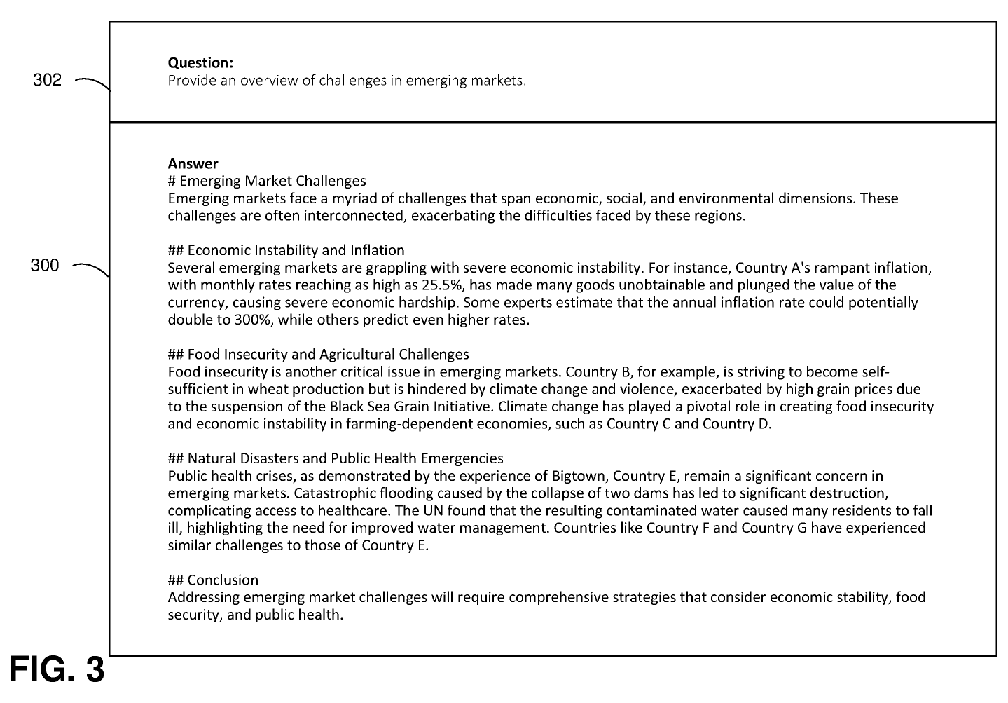

FIGS. 3-7 below illustrate how processing pipeline 200 can be applied to a specific example of text content. The example starts with FIG. 3, which shows text content 300. For example, assume that text content 300 is an answer output by generative language model 100 in response to prompt 302, which states “Provide an overview of challenges in emerging markets.” For instance, the prompt can be provided to the generative language model with a collection of news articles that are employed by the generative language model to produce text content 300 as an answer to the prompt.

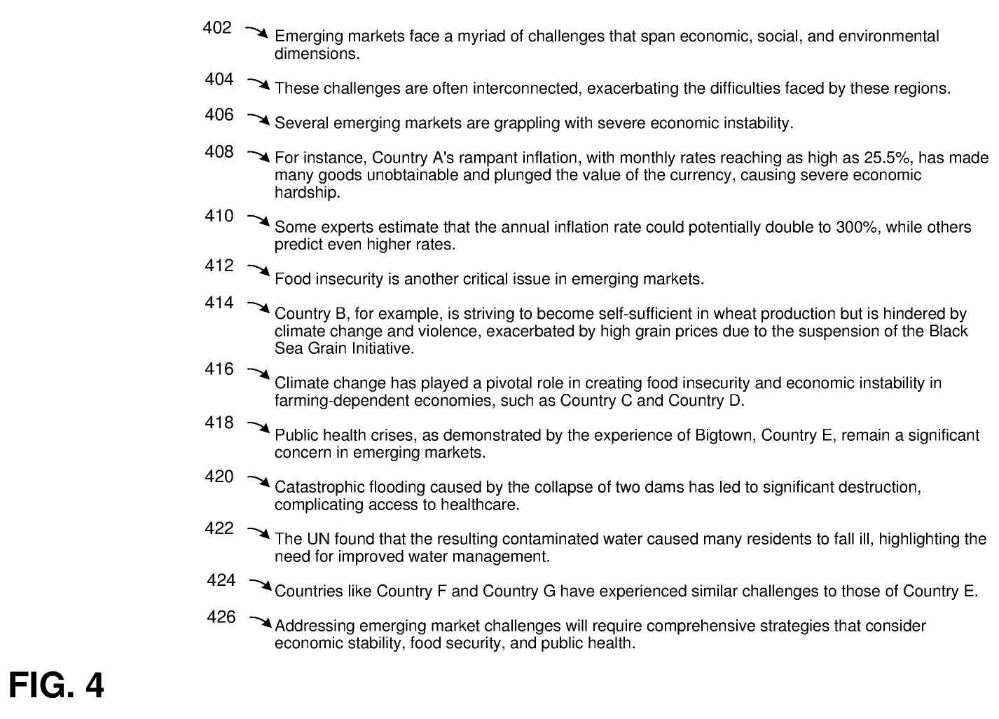

FIG. 4 shows a set of text segments that can be obtained by splitting text content 300 into individual text segments. Here, each text segment corresponds to a sentence in the text content 300. There are a total of 13 text segments – text segment 402, text segment 404, text segment 406, text segment 408, text segment 410, text segment 412, text segment 414, text segment 416, text segment 418, text segment 420, text segment 422, text segment 424, and text segment 426.

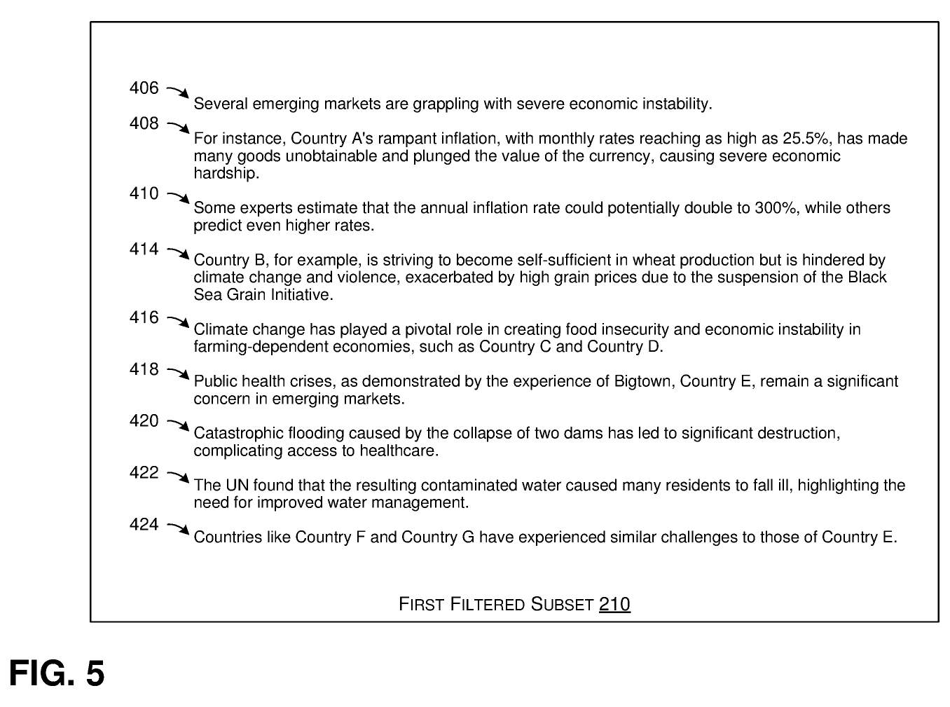

FIG. 5 shows first filtered subset 210 of text segments that remain after the selection filtering stage 206. Here, the selection filtering stage has removed text segment 402, text segment 404, text segment 412, and text segment 426 as lacking verifiable propositions. Thus, the first filtered subset 210 includes the 9 remaining text segments - text segment 406, text segment 408, text segment 410, text segment 414, text segment 416, text segment 418, text segment 420, text segment 422, and text segment 424.

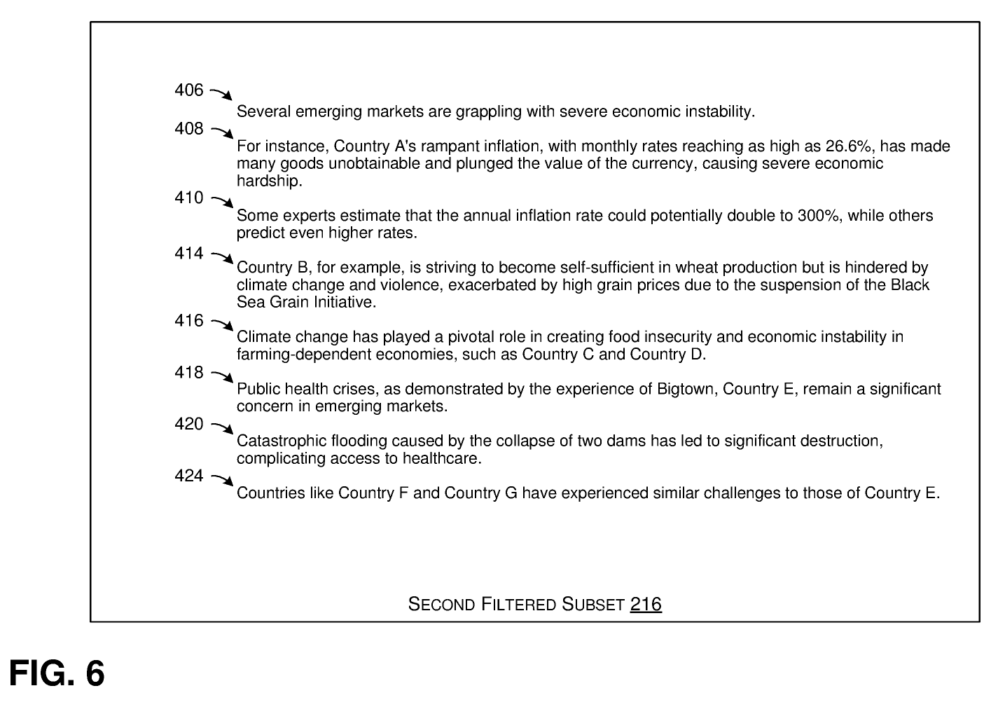

FIG. 6 shows second filtered subset 216 that remains after the ambiguity filtering stage 212. Here, the ambiguity filtering stage has removed text segment 422. Thus, the second filtered text segment includes the 8 remaining text segments - text segment 406, text segment 408, text segment 410, text segment 414, text segment 416, text segment 418, text segment 420, and text segment 424.

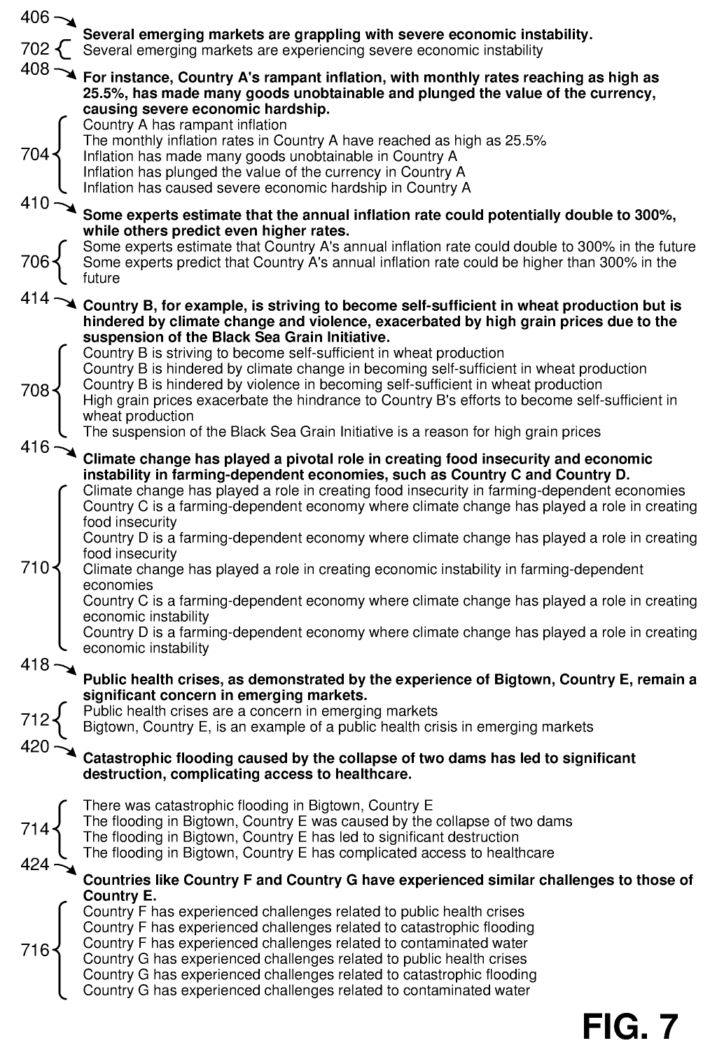

FIG. 7 shows example mappings of propositions to segments from which they were extracted, which can be output by the decomposition stage 218. Each mapping includes a text segment shown in bold and a corresponding set of one or more verifiable propositions extracted from that text segment. Here, text segment 406 is mapped to verifiable proposition set 702, text segment 408 is mapped to verifiable proposition set 704, text segment 410 is mapped to verifiable proposition set 706, text segment 414 is mapped to verifiable proposition set 708, text segment 416 is mapped to verifiable proposition set 710, text segment 418 is mapped to verifiable proposition set 712, text segment 420 is mapped to verifiable proposition set 714, and text segment 424 is mapped to verifiable proposition set 716.

### PROMPTING STRATEGIES

The following describes an example prompting strategy that can be employed to implement certain steps of processing pipeline 200. Recall that the example above involved inputting the initial prompt “Provide an overview of challenges in emerging markets” to generative language model 100, and receiving text content 300 in response. The selection filtering stage 206, ambiguity filtering stage 212, and decomposition stage 218 can all provide three inputs to the generative language model - the initial prompt, an excerpt from the response (e.g., text content 300) to the initial prompt, and a sentence of interest (which is contained in the excerpt). Here, the “sentence of interest” refers to the text segment being currently processed.

The excerpt for a given sentence of interest is employed as context for the generative language model 100 to use to evaluate that sentence of interest. The excerpt can include one or more preceding sentences that occur before the sentence of interest in the original text content, one or more subsequent sentences that occur after the sentence of interest in the original text content, and/or metadata that is associated with the sentence of interest in the original text content. The number of preceding sentences, the number of subsequent sentences, and the specific metadata items that are employed for context can be configurable, e.g., using a configuration file.

In addition, examples and guidance can be provided to the generative language model 100 for each of the selection filtering stage 206, ambiguity filtering stage 212, and decomposition stage 218. For example, during the selection filtering stage, the generative language model can be instructed to consider surrounding sentences when classifying a given sentence of interest. The selection filtering stage can ask the generative language model to reason about whether the sentence of interest contains or does not contain a verifiable proposition, then output its final classification.

As another example, during the ambiguity filtering stage, the generative language model can be instructed that the lack of a full name/acronym/abbreviation does not count as ambiguity. The generative language model 100 can be asked to (1) identify all incomplete names and undefined acronyms/abbreviations in the sentence of interest and whether their full forms are included in the question and/or excerpt, and (2) identify all referential and structural ambiguity in the sentence. For each instance of ambiguity, the generative language model can be asked to determine whether there is a clear resolution using the question and/or excerpt. If the generative language model determines in (2) that at least one instance of ambiguity does not have a clear resolution, then the generative language model will flag that the sentence of interest could not be disambiguated. Otherwise, the generative language model can return a version of the sentence that has all ambiguities clarified and uses full names/acronyms/abbreviations identified in (1).

During the decomposition stage, the generative language model can be instructed that only verifiable information from the sentence of interest should be included in the verifiable propositions that are extracted. The generative language model can be instructed to restate the sentence of interest in alternative forms, then to reason about how to break the sentence of interest down into verifiable propositions. The generative language model can then return a list of verifiable propositions that it identifies in the sentence of interest based on the instructions.

### EXAMPLE GRAPHICAL USER INTERFACE

In some implementations, one or more graphical user interfaces are provided that enable users to interact with text content processed by processing pipeline 200. For instance, a graphical user interface can convey information obtained by invoking the one or more first application interfaces, described above as providing labels of text segments and mappings of verifiable propositions to the text segments from which they were extracted. A graphical user interface can also convey a modified version of the text content obtained by invoking the one or more second applications described above.

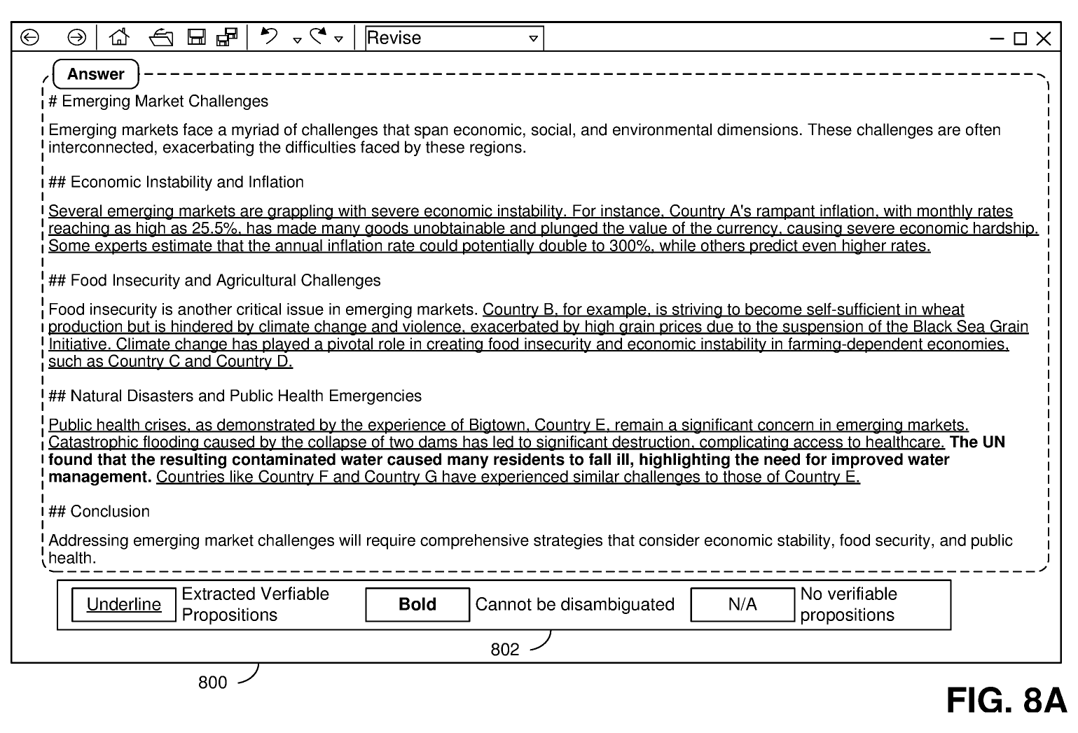

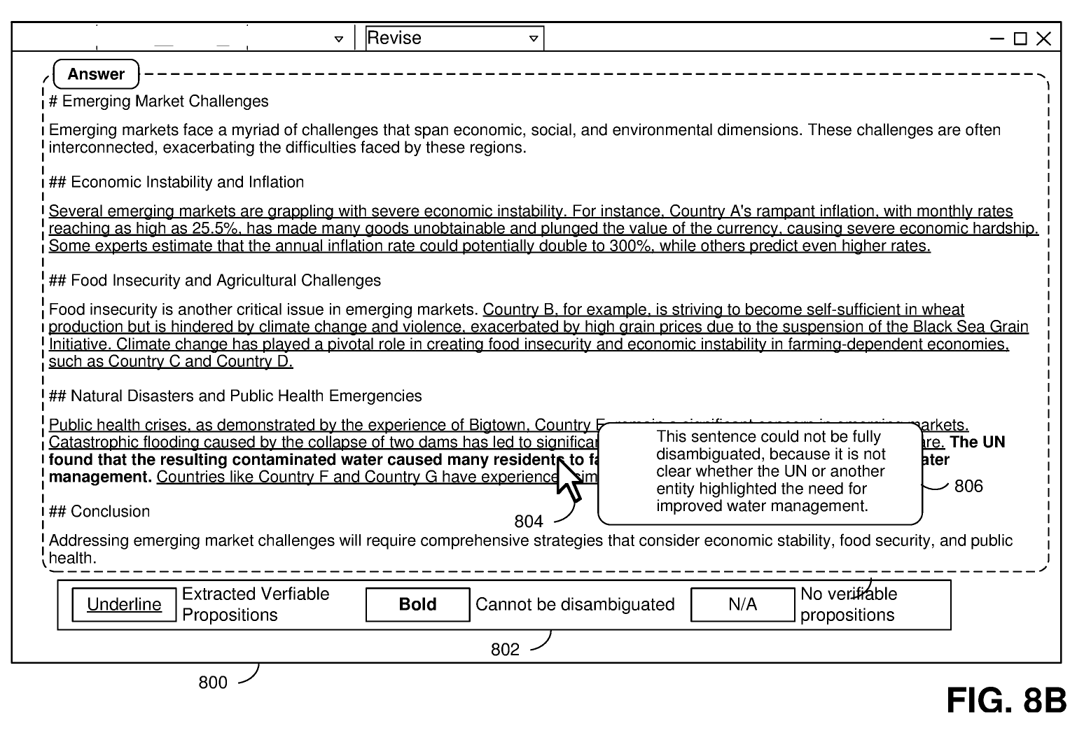

FIG. 8A shows an example graphical user interface 800 with a legend 802 that conveys how each text segment was labeled during processing pipeline 200. In graphical user interface 800, text segments from which verifiable propositions were extracted are underlined, text segments that could not be disambiguated are shown in bold, and text segments from which verifiable propositions could not be extracted are shown in regular non-bold, non-underlined font. The fonts for each text segment can be determined based on the labels output by the one or more first application programming interfaces for each of the corresponding text segments.

FIG. 8B shows a scenario where a user hovers a cursor 804 over a given segment. In response, an explanation 806 is provided on the graphical user interface 800. Here, the explanation conveys why the generative language model was unable to fully disambiguate the corresponding sentence. In other cases, explanations can be displayed for why a given sentence was determined to lack any verifiable propositions.

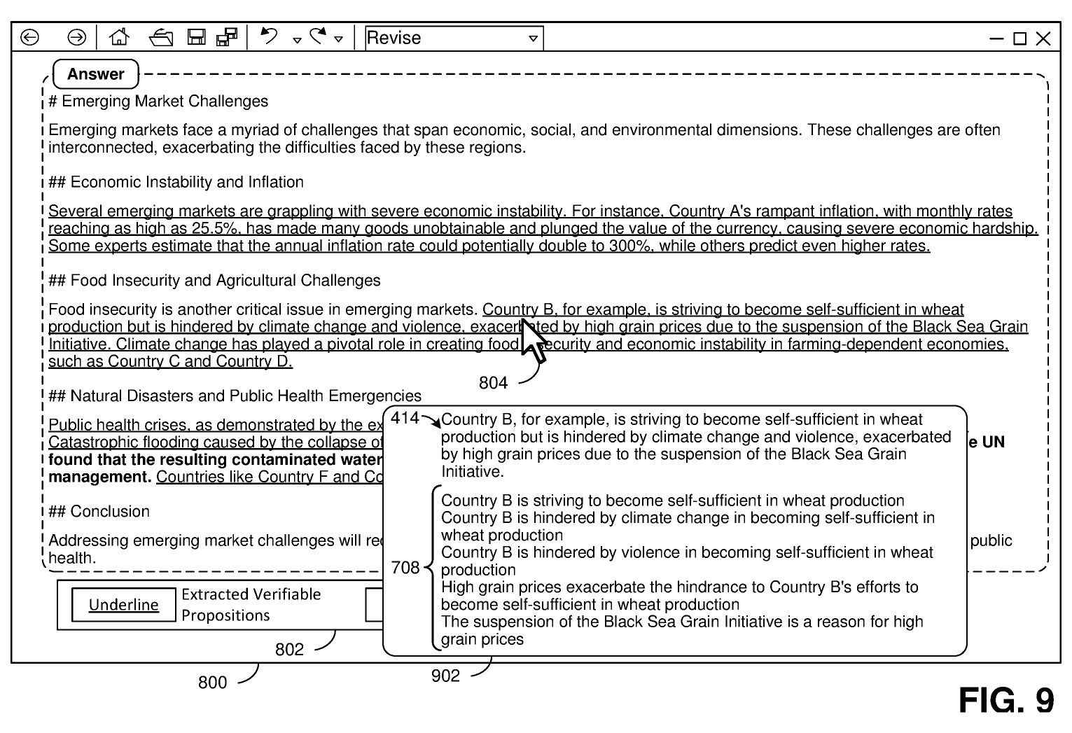

FIG. 9 shows graphical user interface 800 with a popup 902 that is shown when cursor 804 hovers over a corresponding text segment. Here, the popup shows text segment 414 with a verifiable proposition set 708 extracted from text segment 414. Thus, users can navigate the graphical user interface to determine which verifiable propositions were extracted from each corresponding text segment. The popup can be populated with a user-selected text segment and verifiable propositions extracted from that text segment using the mappings provided by the one or more first application programming interfaces.

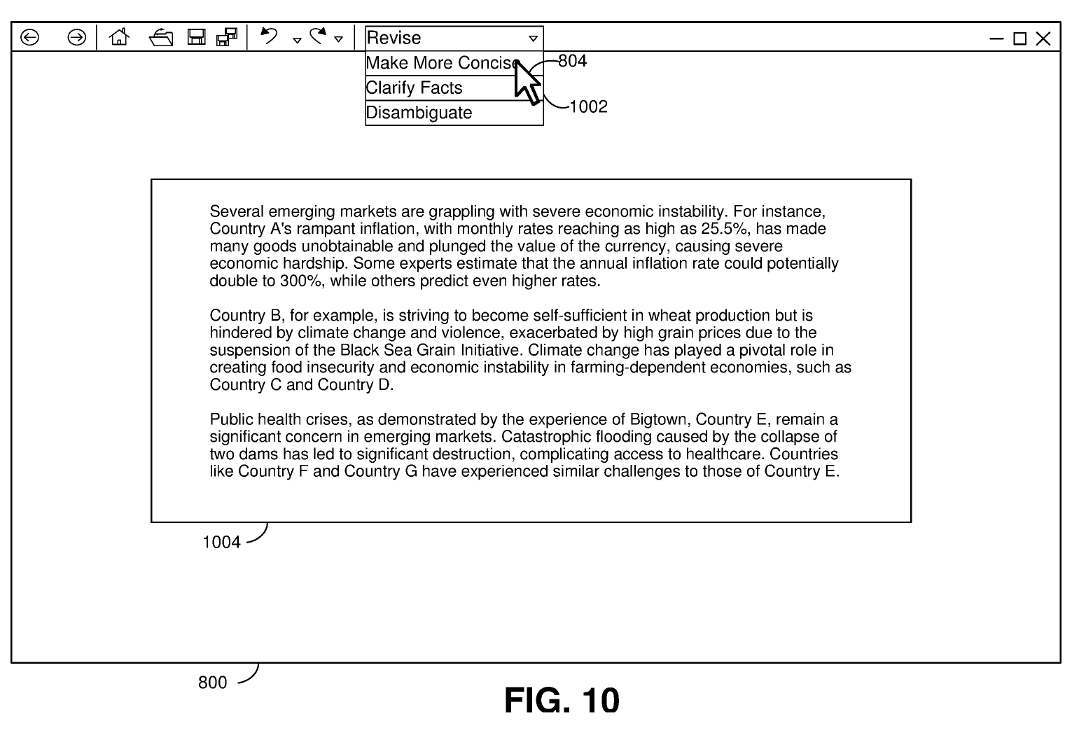

FIG. 10 shows graphical user interface 800 in a scenario where a user has navigated using cursor 804 to a revision drop-down menu 1002. The revision drop-down menu has three options – “Make More Concise,” “Clarify Facts,” and “Disambiguate.” In FIG. 10, the user has selected the “Make More Concise” option. In response, modified text content 1004 has been output via the graphical user interface. Here, the text content 300 has been modified by removing each of the sentences that were identified in processing pipeline 200 as lacking verifiable propositions. For instance, the user navigating to the “Make More Concise” option on the revision menu can invoke the one or more second APIs to obtain modified version of the input text content from which individual text segments that lack verifiable propositions have been removed.

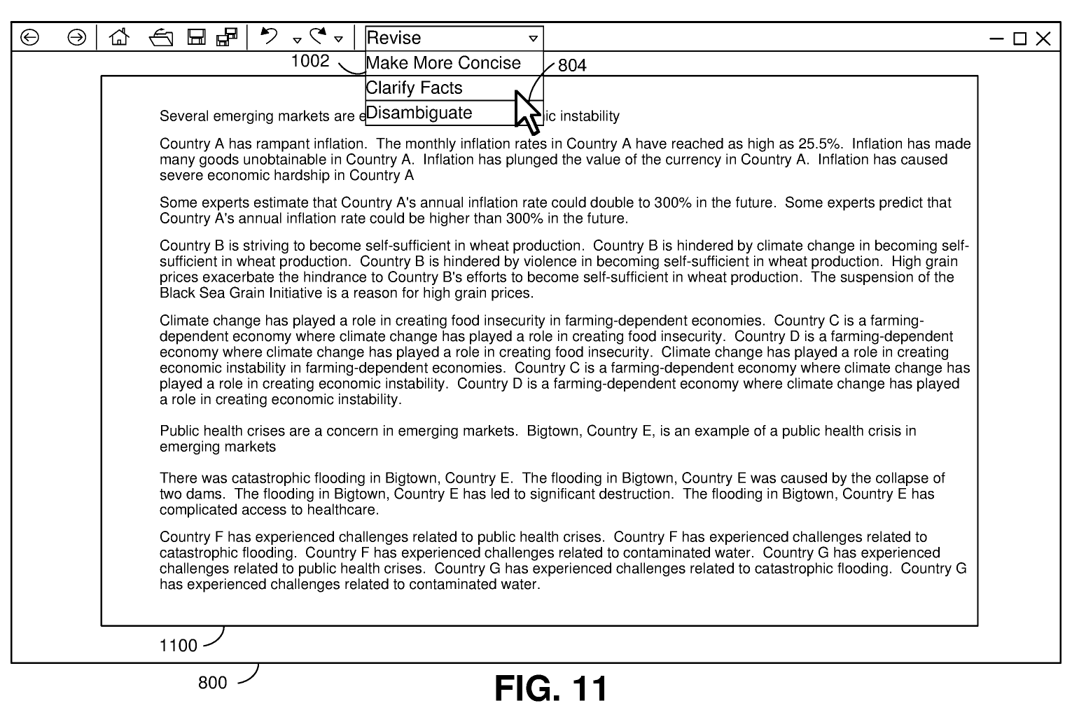

FIG. 11 shows graphical user interface 800 in a scenario where the user has navigated to a “Clarify Facts” option in the revision drop-down menu 1002. In response, modified text content 1100 has been output via the graphical user interface. Here, the text content 300 has been modified by breaking each sentence down into the verifiable propositions extracted that were extracted. For instance, the user navigating to the “Clarify Facts” option on the revision menu can invoke the one or more second APIs to obtain modified version of the input text content that replaces the text segments from the original text content with the extracted verifiable propositions.

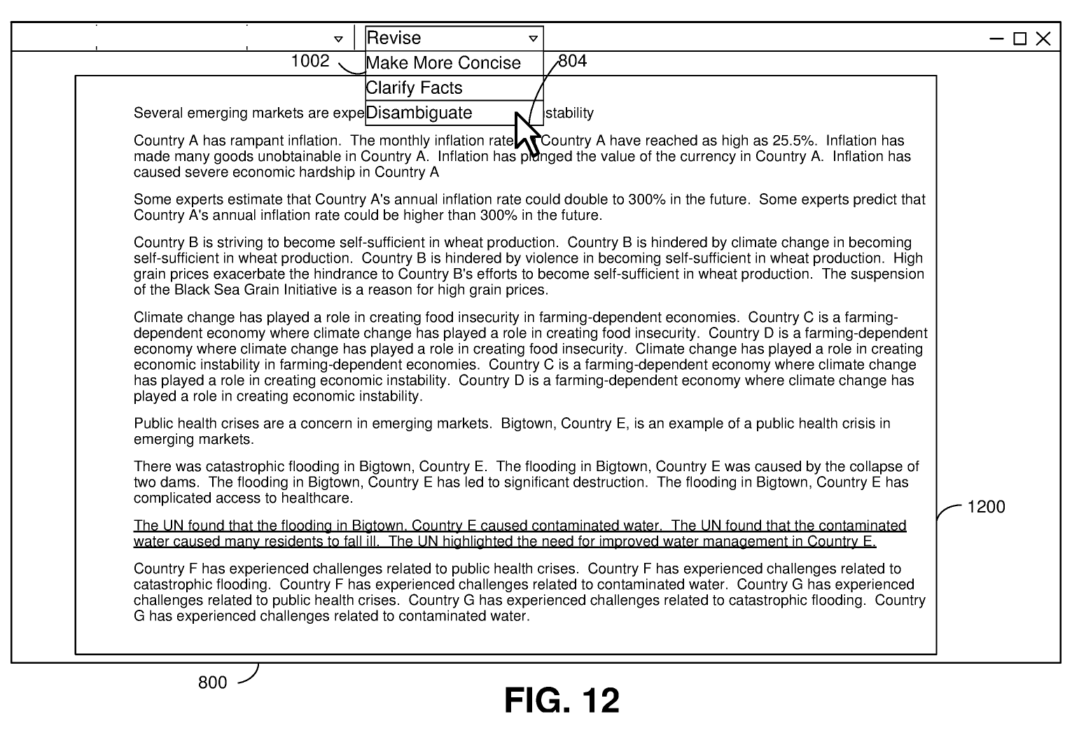

FIG. 12 shows a scenario where the user has navigated to a “disambiguate” option in the revision drop-down menu 1002. In response, modified text content 1200 has been output via the graphical user interface. Here, the sentence “The UN found that the resulting contaminated water caused many residents to fall ill, highlighting the need for improved water management” has been disambiguated and processed to extract three additional verifiable propositions: (1) The UN found that the flooding in Bigtown, Country E caused contaminated water, (2) The UN found that the contaminated water caused many residents to fall ill, and (3) The UN highlighted the need for improved water management in Country E. These verifiable propositions are shown in underline in FIG. 12. For instance, one way to resolve the ambiguity in this sentence involves a retrieval augmented generation approach, where a search engine is queried to identify additional documents relating to the sentence being disambiguated. This can be implemented by resolving the ambiguity based on an explanation output by the generative language model at the ambiguity filtering stage 212. For instance, suppose the generative language model outputs the following: “The sentence could be interpreted as the UN found that the contaminated water caused illness and also highlighted the need for improved water management, or it could be interpreted as the UN only found the contamination and illness, and the author is adding the interpretation about the need for improved water management.”

A web search engine could be queried to identify additional documents relating to the UN and Bigtown, Country E. The additional documents could include one or more sentences that explicitly state whether the UN was the entity that highlighted the need for improved water management. If an additional such document is found stating that the UN is the entity that highlighted the need for improved water management in Country E, then the modified text content can disambiguate the sentence with clarifications as shown in FIG. 12.

Note that disambiguation does not necessarily involve accessing external documents. For instance, in some cases, a text segment can be disambiguated using context provided to the generative machine learning model 100 from the original text content. For instance, refer back to the sentence “The UN found that the resulting contaminated water caused many residents to fall ill, highlighting the need for improved water management” in text content 300. The preceding sentences state that “Public health crises, as demonstrated by the experience of Bigtown, Country E, remain a significant concern in emerging markets. Catastrophic flooding caused by the collapse of two dams has led to significant destruction, complicating access to healthcare.” Thus, given this context, the generative machine learning model could disambiguate the sentence and extract the following verifiable propositions without reference to an external document: (a) The UN found that the flooding in Bigtown, Country E caused contaminated water, and (b) The UN found that the contaminated water caused many residents to fall ill. However, because it is still not clear from the context whether the UN is the entity that highlighted the need for improved water management, the entire sentence cannot be fully disambiguated without referencing an external document. Note also that the text content may have been generated based on some source text (e.g., one or more newspaper articles). In some cases, a given sentence can be disambiguated using the source text without necessarily accessing any external documents.

### EXAMPLE SYSTEM

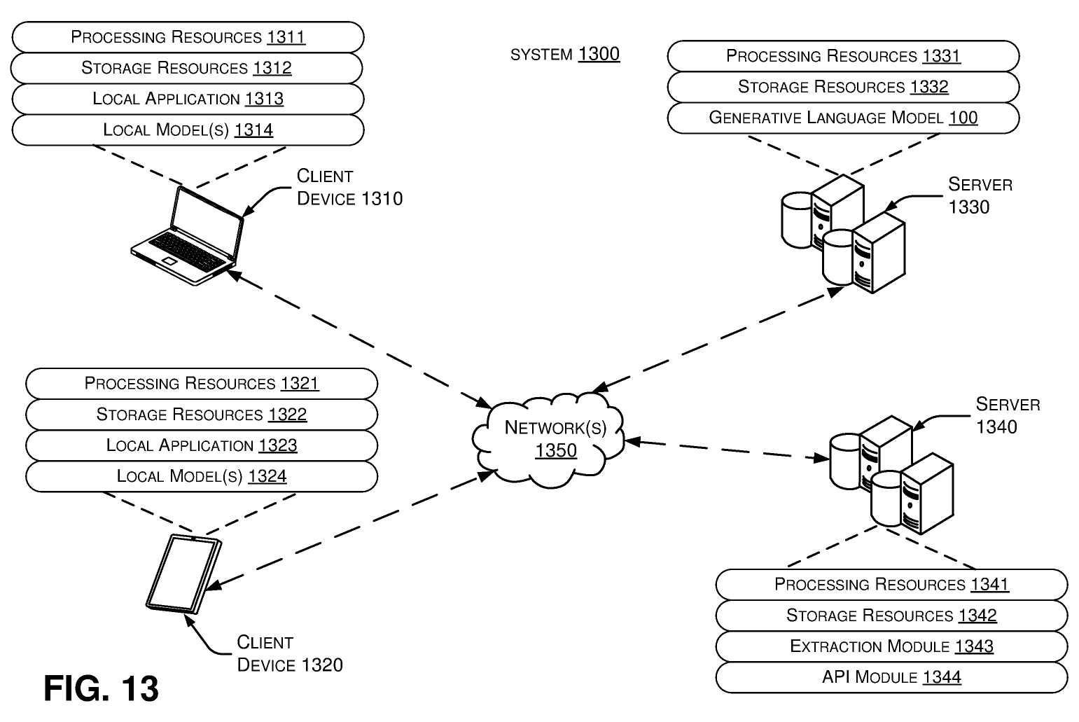

The present implementations can be performed in various scenarios on various devices. FIG. 13 shows an example system 1300 in which the present implementations can be employed, as discussed more below.

As shown in FIG. 13, system 1300 includes a client device 1310, a client device 1320, a server 1330, and a server 1340, connected by one or more network(s) 1350. Note that the client devices can be embodied as mobile devices such as smart phones or tablets, as well as stationary devices such as desktops, etc. Likewise, the servers can be implemented using various types of computing devices. In some cases, any of the devices shown in FIG. 13, but particularly the servers, can be implemented in data centers, server farms, etc.

Client device 1310 can have processing resources 1311 and storage resources 1312, client device 1320 can have processing resources 1321 and storage resources 1322, server 1330 can have processing resources 1331 and storage resources 1332, and server 1340 can have processing resources 1341 and storage resources 1342. Each of these devices may also have various modules that function using the processing and storage resources to perform the techniques discussed herein. The storage resources can include both persistent storage resources, such as magnetic or solid-state drives, and volatile storage, such as one or more random-access memory devices. In some cases, the modules are provided as executable instructions that are stored on persistent storage devices, loaded into the random-access memory devices, and read from the random-access memory by the processing resources for execution.

Client device 1310 can include a local application 1313 and one or more local models 1314, and client device 1320 can include local application 1323 and one or more local models 1324. Server 1330 can host generative language model 100. Server 1340 can host extraction module 1343 and application programming interface (“API”) module 1344.

The various devices of system 1300 can interact as follows. The local applications 1313 and/or 1323 on the client devices can provide text content to server 1340. For instance, the text content can include text generated by generative language model 100 on server 1330 and/or text from documents at least partially authored by humans (e.g., word processing documents, web pages, emails, etc.). The extraction module 1343 on server 1340 can extract text segments (such as sentences) from the text content, filter the extracted text segments according to one or more filtering criteria, prompt the generative language model to extract verifiable propositions from the filtered text segments, and output the verifiable propositions extracted by the generative language model.

The API module 1344 can allow the local applications 1313 and 1323 to call various application programming interfaces to obtain information relating to the processing by the extraction module. For instance, the API module can implement one or more first APIs that output labels for respective text segments that convey whether those text segments include or lack verifiable propositions and/or whether those text segments can be disambiguated. The one or more first APIs can also output mappings of respective verifiable propositions to corresponding sentences from which the respective verifiable propositions were extracted.

The API module 1344 can also allow the local applications to modify the text content using one or more second APIs. For instance, the one or more second APIs can remove text segments that lack verifiable propositions from the text content. The one or more second APIs can also modify individual text segments in the text content with clarifications provided by the generative language model 100. The one or more second APIs can also disambiguate individual sentences in the text content based on output of the generative language model. In this manner, the one or more second APIs can provide an interactive tool that allows a user of the local applications to edit or refine text content.

### EXAMPLE METHOD

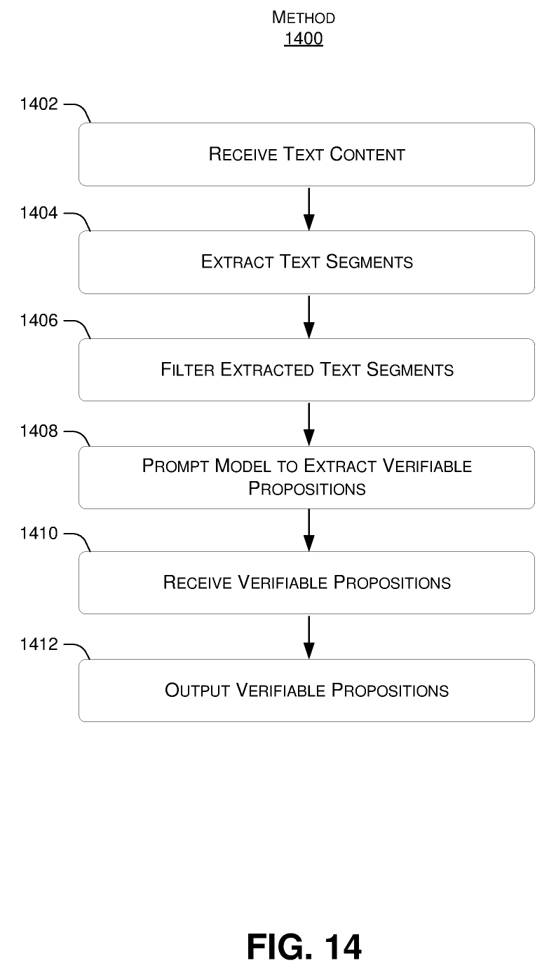

FIG. 14 illustrates an example computer-implemented method 1400, consistent with some implementations of the present concepts. Method 1400 can be implemented on many different types of devices, e.g., by one or more cloud servers, by a client device such as a laptop, tablet, or smartphone, or by combinations of one or more servers, client devices, etc.

Method 1400 begins at block 1402, where text content is received. For example, the text content can be text output by a generative language model, and/or text from a document that was at least partially authored by a human, such as a word processing document, webpage, etc.

Method 1400 continues at block 1404, where text segments are extracted. For example, the text segments can be sentences, phrases, paragraphs, etc. The text segments can be extracted from the text content using a tokenizer (e.g., the Natural Language toolkit or “NTLK” tokenizer), one or more regular expressions, the generative language model, or another machine learning model.

Method 1400 continues at block 1406, where the extracted text segments are filtered. For instance, the filtering can involve prompting a generative language model to evaluate the text segments (e.g., with context such as preceding or subsequent sentences from the text content and/or metadata) and remove text segments meeting one or more filtering criteria. Example filtering stages are shown in FIG. 2 including a selection filtering stage 206 and an ambiguity filtering stage 212. However, in other implementations, fewer and/or more filtering stages can be provided.

Method 1400 continues at block 1408, where a generative language model is prompted to extract verifiable propositions from the filtered subset of text segments that are not removed at block 1406, (e.g., that do not meet any of the filtering criteria). Example prompting strategies are described above.

Method 1400 continues at block 1410, where the verifiable propositions are received from the generative language model. For instance, the generative language model can provide, for each text segment, a label for each sentence, (e.g., cannot be verified, cannot be disambiguated, or successfully extracted propositions), explanations for why individual sentences were labeled as unverifiable or unable to be disambiguated, propositions that were extracted, and mappings of the extracted propositions to the text segments from which they were extracted.

Method 1400 continues at block 1412, where the verifiable propositions are output. For instance, FIG. 7 shows examples of verifiable propositions mapped to the sentences from which they were extracted. Verifiable propositions can also be output at block 1412 via one or more application programming interfaces, as described above. As also described above, application programming interfaces can be employed to modify the text content received at block 1412. In some cases, a graphical user interface can be displayed at block 1412 as shown in FIGS. 8-12.

In some cases, some or all of method 1400 is performed by a server. In other cases, some or all of method 1400 is performed on another device, e.g., a client device, or distributed across multiple devices.

### ADDITIONAL IMPLEMENTATIONS

In some implementations, multiple generations can be performed to verify information in processing pipeline 200. For instance, a configuration file can be provided that specifies (a) the number of generations to perform for any of selection filtering stage 206, ambiguity filtering stage 212, and decomposition stage 218 and (b) the minimum number of "successful" generations required to pass the step. Here, success means the sentence is identified as containing a verifiable proposition, was successfully disambiguated, or had at least one proposition extracted for selection, disambiguation, and decomposition, respectively.

For example, assume that, for the selection filtering stage 206, the number of generations is set to 3 and the minimum number of successes is set to 2. In this case, the generative language model 100 will be prompted three times for each text segment. If the generative language model indicates that a given text segment includes at least one verifiable proposition in at least two of the three responses, then that text segment will pass the selection filtering stage and be included in the first filtered subset 210. If only zero or one of the outputs indicates that the text segment has a verifiable proposition, then that text segment fails the selection filtering stage and is excluded from the first filtered subset.

The use of multiple generations at individual stages of processing pipeline 200 can be useful for several reasons. First, this approach allows some control over the level of confidence in the output of generative language model 100. If high confidence is desired, then more generations with a relatively higher number of successes can be employed. If lower confidence is acceptable, the number of generations and/or number of successes can be reduced. This can be particularly useful in the ambiguity filtering stage 212, where multiple generations can be helpful for disambiguating multiple instances of linguistic ambiguity.

As a further point, variations on the aforementioned filtering stages can be implemented. For instance, in the description above, the selection filtering stage 206 was explained as prompting the generative language model to act as similarly to a binary classifier, e.g., each text segment is classified as either containing a verifiable proposition or not containing a verifiable proposition. In further implementations, the selection filtering stage can also involve promoting the generative language model to rewrite a given text segment by removing unverifiable information so that the rewritten text segment contains only one or more verifiable propositions. For example, if the original text segment is “Another example of a notable technology is GitHub Copilot, which helps users write code faster, highlighting a transformative shift in programming,” the generative language model might output “GitHub Copilot helps users write code faster.” Thus, in these implementations, the following possible outcomes occur in the selection filtering stage: (1) the generative language model indicates that a text segment does not contain a verifiable proposition and is filtered out, (2) the generative language model indicates that a text segment includes a verifiable proposition and is added, unmodified, to the first filtered subset 210, or (3) the generative language model returns a modified version of the text segment where unverifiable information has been removed, and the modified version of the text segment is added to the first filtered subset.

As another example, recall that the ambiguity filtering stage 212 can filter out text segments that the generative language model indicates cannot be disambiguated given the context. As also noted above, in some implementations, the generative language model can rewrite a given text segment to remove ambiguity. In these implementations, the rewritten text segments can be added to the second filtered subset 216 in place of the original text segments. For example, if the original text segment was “They passed a law banning plastic bags” and the context indicates that “they” corresponds to California, then the disambiguation step will return “California passed a law banning plastic bags” which can be included in the second filtered subset.

In addition, as noted above, other types of filtering stages can be employed. For instance, in some cases, text content can have text segments that are partially or entirely redundant. In some implementations, the generative language model is prompted to identify fully or partially redundant text segments. Fully redundant text segments can be filtered out, and partially redundant text segments can be modified to remove individual redundant propositions. As another example, a centrality filter could be employed in a similar manner. Text segments that are entirely unrelated to the central topic of the text content can be removed by filtering, and text segments with propositions unrelated to the central topic can be modified by removing those unrelated propositions.

In further examples, one or more application programming interfaces can be provided for formal logic processing using extracted propositions. For example, assume a verifiable proposition stating “District Policy for school District ABC states that, if it is below 0 degrees, schools in District ABC will close” is extracted from a document. Then, assume the verifiable proposition “Schools were open in District ABC on December 14, 2023” is extracted from another document. Formal logic processing can be applied to these two statements to infer that it was not below 0 degrees on December 14, 2023, because schools were open on that day. More generally, one or more application programming interfaces can be provided to output verifiable propositions that can be inferred using formal logic from one or more other verifiable propositions that are directly extracted from text content. As another example, application programming interfaces can be provided to output logically-related propositions derived from an extracted proposition, e.g., the contrapositive, converse, and/or inverse of a given proposition.

In addition, some implementations provide an application programming interface for evaluating document quality according to one or more metrics. For instance, the total number of verifiable claims in a given document can be used as a metric to evaluate the comprehensiveness of the document. The number or percentage of text segments that cannot be disambiguated can be used as an understandability metric, with documents having many or a high percentage of text segments that cannot be disambiguated being deemed relatively confusing. The ratio of text segments with verifiable propositions to those without can be used as a signal-to-noise ratio metric, with documents having mostly text segments with verifiable propositions being characterized as having relatively lower noise. These metrics can be provided in an application, such as a word processing application, to help users improve document quality by editing individual text segments that lack verifiable propositions or that cannot be disambiguated. In some cases, revised text segments can be generated with generative language model 100 and output as suggestions via the application. As another example, any of the aforementioned metrics can be utilized for ranking documents in response to a search query, with documents characterized as being relatively comprehensive, understandable, and/or with a high signal-to-noise ratio tending to be ranked relatively higher than other documents.

In addition, some implementations may employ vision language models for certain aspects of the disclosed techniques. For example, consider a text segment that states “The animal eating grass cannot be seen by the lion.” Assume that a vision language model is employed to process an image that shows an antelope eating grass with several other animals (e.g., a hyena and a buffalo) doing something other than eating grass. A vision language model can be applied to that image to output statements such as “The image shows a buffalo standing in water, a hyena lying in the dust, and an antelope eating grass.” Given the output of the vision language model as additional context, the disclosed implementations can infer that the antelope cannot be seen by the lion.

### TECHNICAL EFFECT

As noted previously, generative machine learning has not been widely integrated into everyday computing devices. Thus, rudimentary human-computer interaction techniques tend to predominate, e.g., by having users manually enter prompts to a generative machine learning model. Thus, it can be difficult for users to employ a generative machine learning model to revise text content, whether that text content is human-authored or generated by a machine learning model.

The disclosed implementations provide a processing pipeline that can automatically extract verifiable propositions from text content in an automated fashion. By employing several filtering stages in the pipeline, text segments can be removed so that they are not subject to processing later in the pipeline. As a consequence, the generative machine learning model is not invoked on a given text segment once that text segment has been filtered out in an earlier stage. This, in turn, reduces the utilization of processing resources, memory and/or storage resources, and/or network bandwidth that would otherwise be employed for using the generative language model for subsequent stages. For example, if 100 text segments are input via input text content and 50 of them are removed in the selection filtering stage, then the number of calls to the generative language model is reduced by at least 50% for the ambiguity filtering stage 212 and the decomposition stage 218.

Furthermore, as noted above, text segments can be processed in parallel in each stage of the processing pipeline. This allows for relatively lower latency than would be the case if the entirety of the input text content were processed at once. Moreover, by separating the processing into distinct stages that instruct the generative language model to perform precise analysis of each text segment, the generative language model can provide accurate results at each individual stage. An alternative approach that prompted the model to decompose the entire input text content into verifiable propositions in one step would potentially miss certain verifiable propositions and/or mischaracterize individual text segments.

Additionally, manually extracting verifiable propositions is extremely tedious, especially for long, information-rich documents, and does not scale well as documents grow in size and/or more documents are added. By automating the extraction of text segments and context usable by a generative language model to automatically identify verifiable propositions, the disclosed implementations dramatically reduce the burden on the user. In addition, humans are very likely to make mistakes and/or miss verifiable propositions when analyzing text content, and automated disambiguation can be particularly useful in this regard.

### DEVICE IMPLEMENTATIONS

As noted above with respect to FIG. 13, system 1300 includes several devices, including a client device 1310, a client device 1320, a server 1330, and a server 1340. As also noted, not all device implementations can be illustrated, and other device implementations should be apparent to the skilled artisan from the description above and below.

The term “device”, "computer,” "computing device," “client device,” and or “server device” as used herein can mean any type of device that has some amount of hardware processing capability and/or hardware storage/memory capability. Processing capability can be provided by one or more hardware processors (e.g., hardware processing units/cores) that can execute computer-readable instructions to provide functionality. Computer-readable instructions and/or data can be stored on storage, such as storage/memory and or the datastore and, when executed, can cause a processor to perform acts. The term “system” as used herein can refer to a single device, multiple devices, etc.

Storage resources can be internal or external to the respective devices with which they are associated. The storage resources can include any one or more of volatile or non-volatile memory, hard drives, solid state drives, flash storage devices, and/or optical storage devices (e.g., CDs, DVDs, etc.), among others. As used herein, the terms "computer-readable media" and "computer-readable medium" can include signals. In contrast, the terms "computer-readable storage media" and "computer-readable storage medium" excludes signals. Computer-readable storage media includes "computer-readable storage devices." Examples of computer-readable storage devices include volatile storage media, such as RAM, and non-volatile storage media, such as hard drives, optical discs, solid state drives, flash memory, etc.

In some cases, the devices are configured with a general-purpose hardware processor and storage resources. Processors and storage can be implemented as separate components or integrated together as in computational RAM. In other cases, a device can include a system on a chip (SOC) type design. In SOC design implementations, functionality provided by the device can be integrated on a single SOC or multiple coupled SOCs. One or more associated processors can be configured to coordinate with shared resources, such as memory, storage, etc., and/or one or more dedicated resources, such as hardware blocks configured to perform certain specific functionality. Thus, the term “processor,” “hardware processor” or “hardware processing unit” as used herein can also refer to central processing units (CPUs), graphical processing units (GPUs), neural processing units (NPUs), controllers, microcontrollers, processor cores, or other types of processing devices suitable for implementation both in conventional computing architectures as well as SOC designs.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In some configurations, any of the modules/code discussed herein can be implemented in software, hardware, and/or firmware. In any case, the modules/code can be provided during manufacture of the device or by an intermediary that prepares the device for sale to the end user. In other instances, the end user may install these modules/code later, such as by downloading executable code and installing the executable code on the corresponding device.

Also note that devices generally can have input and/or output functionality. For example, computing devices can have various input mechanisms such as keyboards, mice, touchpads, voice recognition, gesture recognition (e.g., using depth cameras such as stereoscopic or time-of-flight camera systems, infrared camera systems, RGB camera systems or using accelerometers/gyroscopes, facial recognition, etc.), microphones, etc. Devices can also have various output mechanisms such as printers, monitors, speakers, etc.

Also note that the devices described herein can function in a stand-alone or cooperative manner to implement the described techniques. For example, the methods and functionality described herein can be performed on a single computing device and/or distributed across multiple computing devices that communicate over network(s) 1350. Without limitation, network(s) 1350 can include one or more local area networks (LANs), wide area networks (WANs), the Internet, and the like.

### ADDITIONAL EXAMPLES

Various examples are described above. Additional examples are described below. One example includes a computer-implemented method comprising receiving text content, extracting text segments from the text content, filtering the extracted text segments by prompting a generative language model to evaluate the text segments according to one or more filtering criteria, and receiving, from the generative language model, responses identifying individual text segments that meet the one or more filtering criteria, the filtering resulting in a filtered subset of text segments having the individual text segments that are identified by the generative language model as meeting the one or more filtering criteria, prompting the generative language model to extract verifiable propositions from the filtered subset of text segments, receiving the verifiable propositions extracted by the generative language model, and outputting the verifiable propositions.

Another example can include any of the above and/or below examples where the filtering comprises initiating parallel processing of respective text segments by the generative language model.

Another example can include any of the above and/or below examples where the text content comprises output of the generative language model or another generative language model.

Another example can include any of the above and/or below examples where the text content is obtained from a document authored at least partially by a human.

Another example can include any of the above and/or below examples where the extracted text segments comprise sentences extracted from the text content using a tokenizer, one or more regular expressions, the generative language model, or another machine learning model.

Another example can include any of the above and/or below examples where the filtering comprises a first filtering stage that removes sentences that the generative language model indicates lack at least one verifiable proposition.

Another example can include any of the above and/or below examples where the filtering comprises a second filtering stage that removes sentences that the generative language model indicates cannot be disambiguated.

Another example can include any of the above and/or below examples where the method further comprises inputting context associated with the extracted sentences to the generative language model, the generative language model employing the context for the first filtering stage and the second filtering stage.

Another example can include any of the above and/or below examples where the context for the extracted sentences include preceding sentences from the text content, subsequent sentences from the text content, and metadata from the text content.

Another example can include any of the above and/or below examples where the second filtering stage involves prompting the generative language model to detect and resolve ambiguity for a particular sentence based at least on particular context for the particular sentence, receiving a disambiguated version of the particular sentence from the generative language model, and including the disambiguated version of the particular sentence in the filtered subset.

Another example can include any of the above and/or below examples where the method further comprises outputting one or more labels for respective sentences indicating whether the generative language model indicates the respective sentences lack at least one verifiable proposition.

Another example can include any of the above and/or below examples where the one or more labels for the respective sentences indicate whether the generative language model indicates the respective sentences cannot be disambiguated.

Another example can include any of the above and/or below examples where the method further comprises outputting mappings of respective verifiable propositions to corresponding sentences from which the respective verifiable propositions were extracted.

Another example can include a system comprising a processor, and a storage medium storing instructions which, when executed by the processor, cause the system to receive text content, extract text segments from the text content, filter the extracted text segments by prompting a generative language model to evaluate the text segments according to one or more filtering criteria, and receiving, from the generative language model, responses identifying individual text segments that meet the one or more filtering criteria, the filtering resulting in a filtered subset of text segments having the individual text segments that are identified by the generative language model as meeting the one or more filtering criteria, prompt the generative language model to extract verifiable propositions from the filtered subset of text segments, receive the verifiable propositions extracted by the generative language model, and output the verifiable propositions.

Another example can include any of the above and/or below examples where the instructions, when executed by the processor, cause the system to provide one or more first application programming interfaces that receive the text content and output at least one of mappings of respective verifiable propositions to corresponding text segments from which the respective verifiable propositions were extracted, or one or more labels for respective text segments, the one or more labels indicating whether the generative language model indicates the respective text segments lack at least one verifiable proposition, or whether the generative language model indicates the respective text segments cannot be disambiguated given associated context.

Another example can include any of the above and/or below examples where the instructions, when executed by the processor, cause the system to receive an explanation from the generative language model indicating a reason that a particular sentence cannot be disambiguated or does not include a verifiable proposition, and output the explanation via the one or more first application programming interfaces.

Another example can include any of the above and/or below examples where the instructions, when executed by the processor, cause the system to provide one or more second application programming interfaces that modify the text content based on output of the one or more first application programming interfaces.

Another example can include any of the above and/or below examples where the one or more second application programming interfaces perform at least one of invoking the generative language model to remove, from the text content, individual text segments that lack verifiable propositions, invoking the generative language model to modify individual text segments in the text content with clarifications provided by the generative language model, or disambiguating individual text segments in the text content based on output of the generative language model.

Another example can include a computer-readable storage medium storing instructions which, when executed by a processing device, cause the processing device to perform acts comprising receiving text content, extracting text segments from the text content, filtering the extracted text segments by prompting a generative language model to evaluate the text segments according to one or more filtering criteria, and receiving, from the generative language model, responses identifying individual text segments that meet the one or more filtering criteria, the filtering resulting in a filtered subset of text segments having the individual text segments that are identified by the generative language model as meeting the one or more filtering criteria, prompting the generative language model to extract verifiable propositions from the filtered subset of text segments, receiving the verifiable propositions extracted by the generative language model, and outputting the verifiable propositions.

Another example can include any of the above and/or below examples where the outputting comprises displaying a graphical user interface identifying first text segments that lack verifiable propositions, first explanations indicating why the first text segments are deemed to lack verifiable propositions, second text segments that cannot be disambiguated, second explanations indicating why the second text segments cannot be disambiguated, third text segments from which the verifiable propositions were extracted, and mappings of the verifiable propositions to corresponding text segments from which the verifiable propositions were extracted by the generative language model.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other features and acts that would be recognized by one skilled in the art are intended to be within the scope of the claims.

1. A computer-implemented method comprising:
receiving text content;
extracting text segments from the text content;
filtering the extracted text segments by:
prompting a generative language model to evaluate the text segments according to one or more filtering criteria; and
receiving, from the generative language model, responses identifying individual text segments that meet the one or more filtering criteria,
the filtering resulting in a filtered subset of text segments having the individual text segments that are identified by the generative language model as meeting the one or more filtering criteria;
prompting the generative language model to extract verifiable propositions from the filtered subset of text segments;
receiving the verifiable propositions extracted by the generative language model; and
outputting the verifiable propositions.

2. The computer-implemented method of claim 1, wherein the filtering comprises:
initiating parallel processing of respective text segments by the generative language model.

3. The computer-implemented method of claim 1, the text content comprising output of the generative language model or another generative language model.

4. The computer-implemented method of claim 1, the text content being obtained from a document authored at least partially by a human.

5. The computer-implemented method of claim 1, wherein the extracted text segments comprise sentences extracted from the text content using a tokenizer, one or more regular expressions, the generative language model, or another machine learning model.

6. The computer-implemented method of claim 5, wherein the filtering comprises a first filtering stage that removes sentences that the generative language model indicates lack at least one verifiable proposition.

7. The computer-implemented method of claim 6, wherein the filtering comprises a second filtering stage that removes sentences that the generative language model indicates cannot be disambiguated.

8. The computer-implemented method of claim 7, further comprising:
inputting context associated with the extracted sentences to the generative language model, the generative language model employing the context for the first filtering stage and the second filtering stage.

9. The computer-implemented method of claim 8, the context for the extracted sentences including preceding sentences from the text content, subsequent sentences from the text content, and metadata from the text content.

10. The computer-implemented method of claim 9, wherein the second filtering stage involves:
prompting the generative language model to detect and resolve ambiguity for a particular sentence based at least on particular context for the particular sentence;
receiving a disambiguated version of the particular sentence from the generative language model; and
including the disambiguated version of the particular sentence in the filtered subset.

11. The computer-implemented method of claim 7, further comprising:
outputting one or more labels for respective sentences indicating whether the generative language model indicates the respective sentences lack at least one verifiable proposition.

12. The computer-implemented method of claim 11, the one or more labels for the respective sentences indicating whether the generative language model indicates the respective sentences cannot be disambiguated.

13. The computer-implemented method of claim 12, further comprising:
outputting mappings of respective verifiable propositions to corresponding sentences from which the respective verifiable propositions were extracted.

14. A system comprising:
a processor; and
a storage medium storing instructions which, when executed by the processor, cause the system to:
receive text content;
extract text segments from the text content;
filter the extracted text segments by:
prompting a generative language model to evaluate the text segments according to one or more filtering criteria; and
receiving, from the generative language model, responses identifying individual text segments that meet the one or more filtering criteria,
the filtering resulting in a filtered subset of text segments having the individual text segments that are identified by the generative language model as meeting the one or more filtering criteria;
prompt the generative language model to extract verifiable propositions from the filtered subset of text segments;
receive the verifiable propositions extracted by the generative language model; and
output the verifiable propositions.

15. The system of claim 14, wherein the instructions, when executed by the processor, cause the system to:
provide one or more first application programming interfaces that receive the text content and output at least one of:
mappings of respective verifiable propositions to corresponding text segments from which the respective verifiable propositions were extracted, or
one or more labels for respective text segments, the one or more labels indicating:
whether the generative language model indicates the respective text segments lack at least one verifiable proposition, or
whether the generative language model indicates the respective text segments cannot be disambiguated given associated context.

16. The system of claim 15, wherein the instructions, when executed by the processor, cause the system to:
receive an explanation from the generative language model indicating a reason that a particular sentence cannot be disambiguated or does not include a verifiable proposition; and
output the explanation via the one or more first application programming interfaces.

17. The system of claim 15, wherein the instructions, when executed by the processor, cause the system to:
provide one or more second application programming interfaces that modify the text content based on output of the one or more first application programming interfaces.

18. The system of claim 17, wherein the one or more second application programming interfaces perform at least one of:
invoking the generative language model to remove, from the text content, individual text segments that lack verifiable propositions;
invoking the generative language model to modify individual text segments in the text content with clarifications provided by the generative language model; or
disambiguating individual text segments in the text content based on output of the generative language model.

19. A computer-readable storage medium storing instructions which, when executed by a processing device, cause the processing device to perform acts comprising:
receiving text content;
extracting text segments from the text content;
filtering the extracted text segments by:
prompting a generative language model to evaluate the text segments according to one or more filtering criteria; and
receiving, from the generative language model, responses identifying individual text segments that meet the one or more filtering criteria,
the filtering resulting in a filtered subset of text segments having the individual text segments that are identified by the generative language model as meeting the one or more filtering criteria;
prompting the generative language model to extract verifiable propositions from the filtered subset of text segments;
receiving the verifiable propositions extracted by the generative language model; and
outputting the verifiable propositions.

20. The computer-readable storage medium of claim 19, wherein the outputting comprises displaying a graphical user interface identifying:
first text segments that lack verifiable propositions,
first explanations indicating why the first text segments are deemed to lack verifiable propositions,
second text segments that cannot be disambiguated,
second explanations indicating why the second text segments cannot be disambiguated,
third text segments from which the verifiable propositions were extracted, and
mappings of the verifiable propositions to corresponding text segments from which the verifiable propositions were extracted by the generative language model.
